(19) United States
(12) Patent Application Publication
(10) Pub. No.: US 2006/0189781 A1
(43) Pub. Date: Aug. 24, 2006

(54) Process and apparatus for the production of a polyurethane binder

(75) Inventors: Susanne Pedersen, Fredensborg (DK); David Murray, Kettering (GB)

Correspondence Address: OLIFF & BERRIDGE, PLC, P.O. BOX 19928, ALEXANDRIA, VA, 22320, US

(73) Assignee: Sika Technology AG, Baar (CH)

(21) Appl. No.: 10/528,068

(22) PCT Filed: Sep. 18, 2003
(86) PCT No.: PCT/DK03/00602

§ 371 Date: Mar. 16, 2006

(30) Foreign Application Priority Data
Sep. 20, 2002 (DK) PA200201382

(51) Int. Cl. C08G 18/16

(52) U.S. Cl. 528/48

(57) ABSTRACT

Process for the production of a polyurethane binder comprising the steps of mixing at the site of use a mixture of an alcohol component and an isocyanate component in a predetermined weight ratio with a catalyst in an amount determined by the desired open time of the binder. Apparatus for the preparation of a polyurethane binder comprising means for dosing an alcohol and an isocyanate component in a predetermined weight ratio to form a mixture means for dosing varying amounts of catalyst to said mixture and means for mixing the dosed components.

The present invention relates to a process for the production of a polyurethane binder from a mixture of an alcohol component, an isocyanate component and a catalyst.

Polyurethane binders of said type are widely used, e.g. for the manufacture of sandwich elements comprising a core layer of an insulation material such as stone wool covered on both sides by coverings of e.g. metal which coverings are attached to the core layer by means of such a binder.

The polyurethane binder for use in the production of such sandwich elements is ordinarily supplied in a ready-to-use form, i.e. with a predetermined ratio between the three main components to the place at which it is to be used and the reaction between said main components to form the binder takes place at a rate which is determined by the existing external conditions such as temperature and the moisure content of the air at the production site.

Thus, under the existing conditions the binder has a given “open time” which is defined as the time within which the binder has to be used. In other words “open time” is the time interval in which the binder has sufficient adhesiveness. If the binder is used later than the “open time”, the strength of the binder is insufficient for the task.

Since the conditions at the production site may change considerably, e.g. during the day and/or during the year, the result is often that the binding operation in the production of sandwich elements is not carried out under optimum conditions.

It has been attempted to eliminate this drawback by using binders with different reactivity and thus “open time”, but the need for having available different binders at the production site does not only present practical, but also cost problems.

The object of the present invention is to provide a process for the production of a ready-to-use binder having a reactivity and thus an open time which can be varied as needed. A special kind of variation is to keep the “open time” constant with varying external conditions.

Keeping the “open time” constant under changing external conditions is desirable since apparatuses and the production speed can be held at an optimum. This is particularly important at open and/or unheated production sites where large differences in temperature and moisture exist, e.g. production sites common in southern Europe.

The process of the invention is characterized in that the alcohol component and the isocyanate component in a predetermined weight ratio are mixed at the site of use with a catalyst in an amount which is determined by the desired open time of the binder.

In a preferred embodiment the binder comprises a large amount of filler.

The invention is based on the discovery that by using alcohol and isocyanate components in a predetermined fixed ratio and by mixing said components with varying amounts of catalyst, binders having desired open times are obtainable and that the mixing of the catalyst, alcohol and isocyanate can be carried out in an uncomplicated manner at the site of use.

Thus, by using the process according to the invention it is possible by using an alcohol component and an isocyanate component in a weight ratio of 5.3:1 and by varying the amount of catalyst from 0.0000015:1 to 0.02:1, preferably from 0.001:1 to 0.02:1, relative to the volume of the mixture of alcohol and isocyanate to vary the open time of such a binder from about 2 to about 110 min, preferably from about 50 to 110 min.

The invention will be described hereafter with reference to a binder consisting of three components, viz. an alcohol, an isocyanate and a catalyst, but it is to be understood that it is also suitable for the production of binder comprising more than three components.

The alcohol and the isocyanate components may be supplied to the site of use as a mixture of the two components in a predetermined ratio in the form of a prepolymer and the user of the binder will then prepare the final mixture by admixing the catalyst with the prepolymer. The three components may also be supplied separately and in that case the end user has to prepare the mixture of all three components e.g. by first preparing a mixture of alcohol and isocyanate and by subsequently admixing the catalyst with said mixture.

Furthermore, the alcohol and isocyanate components may be supplied in the form of a prepolymer.

In order to obtain a uniform distribution of the relatively small amount of catalyst, the latter is preferably admixed with part of the mixture e.g. 10% of one or both of the two other components, whereafter the mixture thus prepared is mixed with the remaining part of the other main component(s).

In a preferred embodiment the catalyst is mixed with the isocyanate because the isocyanate has a lower viscosity than the alcohol component and therefore the distribution of the catalyst is more uniform. In one of the embodiments of the invention the viscosity of the isocyanate is in the range from 150 to 250 mPas and viscosity of the alcohol component including a filler is in the range from 35000 to 60000 mPas.

As used herein the term “alcohol” means an organic compound containing one or more hydroxy groups. Thus, it also encompasses a compound which in addition to at least one hydroxy group contains another functional group such as a carboxy group.

The alcohol component of the binder prepared by the process of the invention is preferably a castor oil, i.e. a vegetable oil obtained from Recinus communis. Castor oil contains a hydroxy fatty acid (recinoleic acid) as its major component. The alcohol component preferably comprises a mixture of castor oil and a polyol such as a polyetherpolyol based on sorbitol.

The polyol has the effect of increasing the mechanical strength of the binder.

The alcohol component may contain minor amounts, i.e. up to about 4% by weight, of various additives such as a moisture absorber, a wetting agent and a rheology improving additive.

Furthermore, the alcohol component may contain substantial amounts e.g. 50-75% by weight of a filler such as calcium carbonate.

The isocyanate component is preferably methylene diisocyanate (MDI), diphenylmethane-4,4′-diisocyanate or diphenylmethane-2,4′-diisocyanate.

The catalyst component is preferably one or more tertiary amines. Examples of suitable tertiary amines are benzyldimethylamine and diethylaminoethanol.

The mechanism of catalysis by a tertiary amine involves the donation of electrons by the tertiary amine to the carbonyl group of the isocyanate group resulting in the formation of a complex intermediate.

The catalytic activity of the tertiary amine depends on its structure and basicity and increases with increasing basicity and is reduced by increasing steric hindrance of the amine nitrogen.

It may be desirable to use a catalyst comprising a mixture of a tertiary amine and an organo-metallic catalyst in order to meet desired product specifications of the binder.

Such organo-metallic catalysts accelerate the urethane reaction. Tin compounds form a preferred group of organo-metallic catalysts. Such compounds act as Lewis acids and are generally believed to function by interacting with basic sites within the isocyanate and alcohol compounds.

The invention also relates to an apparatus for the preparation of a binder comprising a mixture of an alcohol component, an isocyanate component and a catalyst, said apparatus comprising means for dosing the alcohol and the isocyanate components in a predetermined weight ratio, means for dosing varying amounts of catalyst and means for mixing the dosed components.

In a preferred embodiment of the apparatus of the invention the means for dosing the alcohol and isocyanate components comprises two axially aligned cylinder pumps having a common piston rod and the means for dosing the catalyst component comprises a third cylinder pump the piston rod of the latter cylinder pump being connected with the common piston rod of the axially aligned pumps via an adjustable lever mechanism allowing the movement of the piston rod of the third cylinder pump to be varied relative to the movement of the common piston rod.

The use of an adjustable lever mechanism to vary the amount of catalyst makes the apparatus easy to operate even for persons who are unfamiliar with the production of binder.

The invention will be described in further detail with reference to the drawing in which

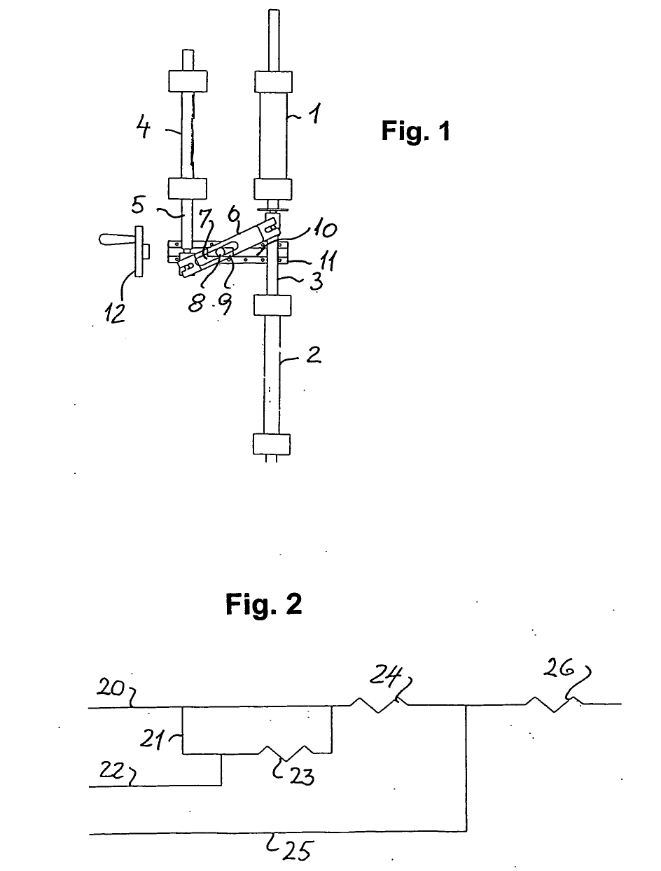

FIG. 1 schematically illustrates a preferred embodiment of the apparatus of the invention and

FIG. 2 is a flow diagram illustrating a preferred method of forming a three-component mixture.

The apparatus illustrated in FIG. 1 comprises a first cylinder pump 1 for the alcohol component of a polyurethane binder, a second cylinder pump 2 for isocyanate component, said cylindrical pumps having a common piston rod 3. The cylinder pumps 1 and 2 are connected with means (not shown) for supplying alcohol and isocyanate components, respectively, to the pumps and have discharge conduits (not shown) for discharging said components and bringing the two components together. The piston rod 3 is connected with means (not shown) for moving the rod between two positions which determine the amount of alcohol and isocyanate component, respectively, discharged by the pumps 1 and 2.

The apparatus also comprises a third cylinder pump 4 having a piston rod 5 which is connected with one end of a lever mechanism 6 having a longitudinally extending slit 7. The other end of the lever mechanism 6 is connected to the piston rod 3.

A tap 8 provided on a glider 9 which is longitudinally moveable in a slit 10 in a guide 11 exends into the slit 7 of the lever mechanism.

The adjustment of the longitudinal position of the glider 9 is effected with a handle 12.

A given stroke length will result in the dosing of alcohol and isocyanate components in a predetermined relative amount and the position of the tap 8 in the slit 7 of the lever mechanism 6 will determine the amount of catalyst component dosed by the third cylinder pump 4.

By using an apparatus as illustrated in FIG. 1, it is possible to continuously vary the amount of catalyst in a mixture of 100 parts by volume of alcohol component and 25 parts by volume of isocyanate component from e.g. 0.1 to 5.

The flow diagram illustrated in FIG. 2 comprises a supply conduit 20 for alcohol component. A conduit 21 branches off from the conduit 20 and is connected with a supply conduit 22 for catalyst.

The part of the alcohol component which is branched off by the branch conduit 21 and is mixed with catalyst supplied through the supply conduit 22 in a mixing zone 23 before the mixture thus formed is combined with the remaining part of the alcohol component passing through the conduit 20. The combined materials are mixed in a further mixing zone 24 before they are combined with isocyanate component supplied through a further conduit 25. The combined materials are finally mixed in a final mixing zone 26 to form the final binder composition.

The invention will be described in still further detail with reference to the following examples.

### COMPARISON EXAMPLE

The apparatus illustrated in FIG. 1 was adjusted so as to prepare a binder consisting of 100 parts by weight of a binder basis containing a mixture of polyols and 19 parts by weight of isocyanate.

2K PUR Binder Base
35% polyols (e.g. castoroil)
60% filler (e.g. CaCO₃)
5% additives

Hardener
100% diisocyanate (e.g. p-MDI with a NCO content of approx. 31.5)

Catalyst
0.2% DBTDL (Di-butyl-tindilaurate)
99.8% solvent

“Open time”

“Open time” of the mixture without catalyst was determined at three different temperatures on relevant use materials and the results obtained were:

| Temperature | “Open time” |
|---|---|
| 18° C. | 100 min. |
| 23° C. | 80 min. |
| 30° C. | 45 min. |

The temperature plays a vital role as seen in the table.

### EXAMPLE 1

The apparatus illustrated in FIG. 1 was adjusted so as to prepare polyurethane binders having predetermined “open time”, at an ambient temperature of 23° C. (*). This yields a process time advantage in the manufacturing of different sandwich types.

| | | | |
|---|---|---|---|
| 1) | “Open time” 80 min. | | |
| | 2K PUR binder base | 100 | parts by weight |
| | Isocyanate | 19 | parts by weight |
| | Catalyst | 0.0 | parts by weight |
| 2) | “Open time” 70 min. | | |
| | 2K PUR binder base | 100 | parts by weight |
| | Isocyanate | 19 | parts by weight |
| | Catalyst | 0.25 | parts by weight |
| 3) | “Open time” 60 min. | | |
| | 2K PUR binder base | 100 | parts by weight |
| | Isocyanate | 19 | parts by weight |
| | Catalyst | 1 | parts by weight |

The example gives a process time saving of 20 minutes per sandwich.

(*) “Open time” is determined according to Beck-Koller. The method is ordinarily used and involves a mechanically driven needle being in contact with a wet film (100 μm) on a support material (glass). During curing the needle slides through the film and leaves a trail. At the beginning the binder will close the trail because of the low viscosity, but as the reaction continues the viscosity will rise and the trail remains open. This point is known as “Start-of-Open-Trace” (SOT), which is taken as the “open time”. The next time of interest is when the film is cured as much as the needle no longer can penetrate but only glide upon the film. This point is also known as “End-of-Open-Trace” (EOT). The values will vary with changing temperature. The method is only dependent on the binders characteristics, i.e. materially independent.

### EXAMPLE 2

The apparatus illustrated in FIG. 1 was adjusted so as to prepare polyurethane binders having a constant “open time” (SOT), viz. 70 minutes at ambient temperatures from 18 to 23° C. This yields a process time advantage in the manufacturing of different sandwich types under conditions with rising temperatures (morning to evening).

| | | | |
|---|---|---|---|
| 1) | At 18° C., “Open time” 70 min. | | |
| | 2K PUR binder base | 100 | parts by weight |
| | Isocyanate | 19 | parts by weight |
| | Catalyst | 1 | parts by weight |
| 2) | At 23° C., “Open time” 70 min. | | |
| | 2K PUR binder base | 100 | parts by weight |
| | Isocyanate | 19 | parts by weight |
| | Catalyst | 0.25 | parts by weight |

The alternative would be use of a binder with constant composition, e.g. the uncatalyzed standard 2K PUR binder. This would give an “Open time” of 100 minutes at 18° C., e.g. in the morning and 80 at 23° C., e.g. in the evening. The process time saving is therefore 30 minutes in the morning and 10 minutes in the evening.

1-11. (canceled)

12. A process for the production of a polyurethane binder from a mixture of an alcohol component, an isocyanate component and a catalyst, CHARACTERIZED in that the alcohol and isocyanate components in a predetermined weight ratio are mixed at the site of use with a catalyst in an amount which is determined by the desired open time of the binder.

13. A process for the production of a polyurethane binder from a prepolymer, which is prepared from a mixture of a alcohol component and a isocyanate components in a predetermined weight ratio, and a catalyst, CHARACTERIZED in that the prepolymer is mixed at the site of use with a catalyst in an amount which is determined by the desired open time of the binder.

14. A process according to claim 12, CHARACTERIZED in that the alcohol component comprises castor oil.

15. A process according to claim 14, CHARACTERIZED in that the alcohol component also comprises a polyol.

16. A process according to claim 12, CHARACTERIZED in that the isocyanate component is diphenylmethane-4,4′-diisocyanate and/or diphenylmethane-2,4′-diisocyanate.

17. A process according to claim 12, CHARACTERIZED in that the catalyst is a tertiary amine.

18. A process according to claim 12, CHARACTERIZED in that the catalyst is an organo-metallic compound.

19. A process according to claim 18, CHARACTERIZED in that the organometallic compound is a tin compound.

20. A process according to claim 17, CHARACTERIZED in that the catalyst comprises both a tertiary amine and an organo-metallic compound.

21. A process according to claim 12, CHARACTERIZED in that the catalyst is mixed with part of the alcohol and/or the isocyanate and that the mixture thus obtained is subsequently mixed with the remaining part of the alcohol and/or isocyanate.

22. An apparatus for the preparation of a binder comprising a mixture of an alcohol component, an isocyanate component and a catalyst, CHARACTERIZED in that it comprises means for dosing the alcohol and isocyanate components, in a predetermined weight ratio, means for dosing varying amounts of catalyst and means for mixing the dosed components.

23. An apparatus according to claim 22, CHARACTERIZED in that the alcohol component and an isocyanate component in a predetermined weight ratio are present in form of a prepolymer.

24. An apparatus according to claim 22, CHARACTERIZED in that the means for dosing the alcohol and isocyanate components comprises two axially aligned cylinder pumps having a common piston rod, that the means for dosing the catalyst is a third cylinder pump, having a piston rod which is connected with the common piston rod of the axially aligned pumps via an adjustable lever mechanism allowing the movement of the piston rod of the third cylinder pump to be varied relative to the movement of the common piston rod.
